(19) United States
(12) Patent Application Publication
(10) Pub. No.: US 2021/0285287 A1
(43) Pub. Date: Sep. 16, 2021

(54) Ladder Lift Housing and Release

(71) Applicant: Lawrence Henry Schumacher, Menifee, CA (US)

(72) Inventor: Lawrence Henry Schumacher, Menifee, CA (US)

(21) Appl. No.: 16/814,935

(22) Filed: Mar. 10, 2020

(51) Int. Cl. E06C 7/16; E06C 1/39

(52) U.S. Cl. CPC E06C 7/16; E06C 1/39

(57) ABSTRACT

My invention is a housing that provides a means to enclose, mount and facilitate the operation of a Ladder Lift on any standard step ladder of various heights. It houses the mechanical workings of a Ladder Lift and provides a sealed enclosure that holds them in place as well as guides for its sliding shafts. A single horizontal release handle mechanism slides vertically to simultaneously activate the dual Ladder Lift release clamps, thus permitting the raising and lowering of the Ladder Lift cross bar to various heights.

### BACKGROUND OF THE INVENTION

This invention relates to the Ladder Lift with Swivel Tray and provides a means of enclosing its mechanics, providing a simpler method of mounting the device to a standard step ladder, as well as providing a release handle.

Further objects and advantages of my invention will become apparent through consideration of the drawings and ensuing description.

### BRIEF SUMMARY OF THE INVENTION

In the garage door opener installation trade, as well as other trades that require the temporary support of materials overhead, the Ladder Lift, as originally designed, provides a means to support said materials at various heights above an A-frame ladder in order to allow the worker to free up his hands to secure a garage door opener or other material to the ceiling. Its original design was such that it is mounted to a ladder without any release mechanism enclosure and said release mechanism is placed inside the upper stepwell of the ladder, thus making the overall width of the Ladder Lift narrow. My invention not only widens the Ladder Lift but removes the release and locking mechanism from inside the upper stepwell and places it flat and inside a protective housing that is mounted above the top stepwell, thus improving safety, support of materials, and smoother and easier operation.

### BRIEF DESCRIPTION OF THE SEVERAL VIEWS OF THE DRAWING

FIG. 1: Front view of open housing. This view shows housing frame (12), upper holes (10) for passage of the Ladder Lift slides, lower holes (14) for the Ladder Lift slide tubes, release cams (16), release handle frame (18), release handle (20) and the stationary release frame guide (22).

FIG. 2: Top view of the housing. This view shows both front and rear halves (12) of the housing assembled and the upper Ladder Lift slide holes (10).

FIG. 3: Bottom view of the housing. This view shows the bottom of the housing halves assembled (12), lower holes (14) for the Ladder Lift slide tubes, release handle frame (18), release handle (20) and the stationary release frame guide (22).

FIG. 4: Front assembled view. This view shows the assembled housing (12) with assembly and mounting screws, and the release handle (20).

FIG. 5: Front view of open housing with Ladder Lift mechanism installed. This view shows the Ladder Lift mechanism comprising the lifting horizontal support bar (28), slide bars (30), slide tubes (24), and spring-loaded clamps (26) as they would be installed in the Ladder Lift Housing (12) and showing their working relationship with the release cams (16), release handle frame (18), release handle (20) and the stationary release frame guide (22).

FIG. 6: Perspective view of Ladder Lift Housing on ladder. This view shows the Ladder Lift Housing (12) and Release (20) installed on a ladder encompassing the Ladder Lift mechanism comprising the lifting horizontal support bar (28), slide bars (30), and slide tubes (24).

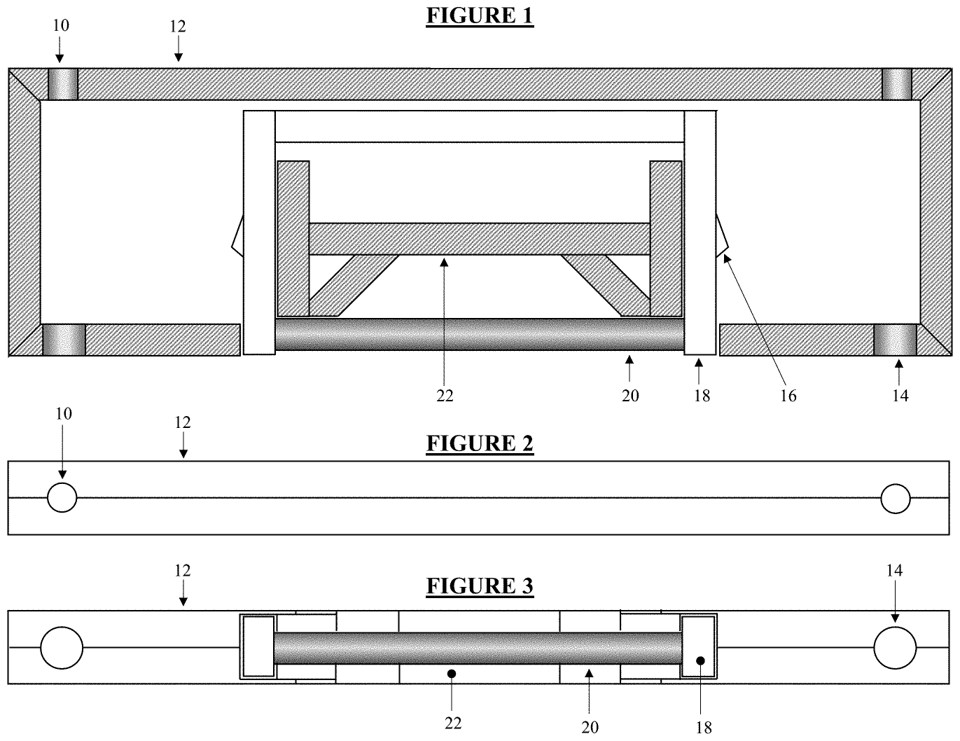

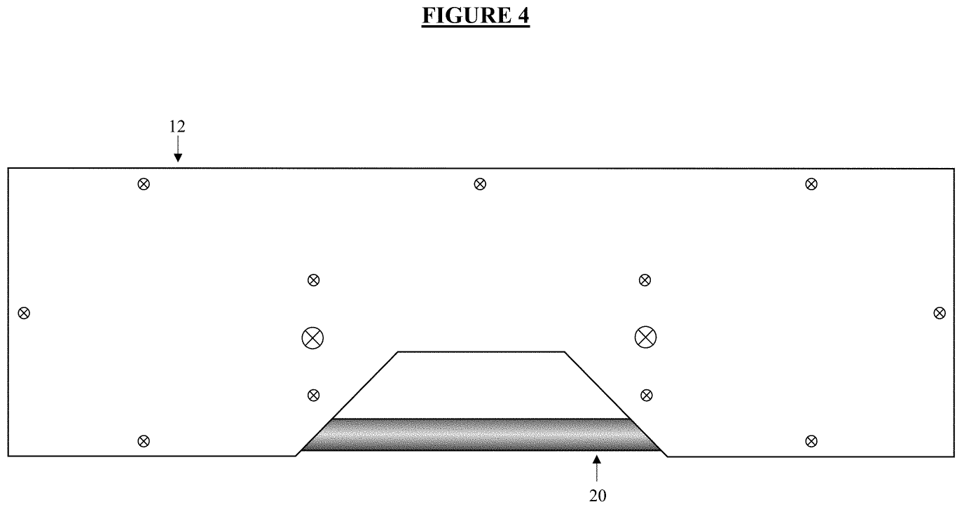

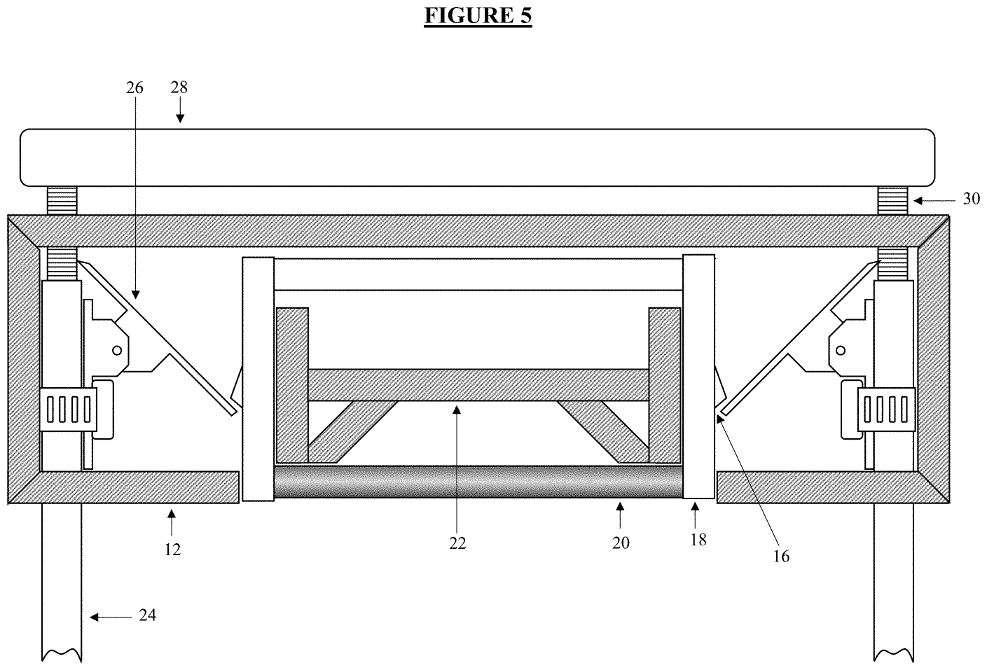

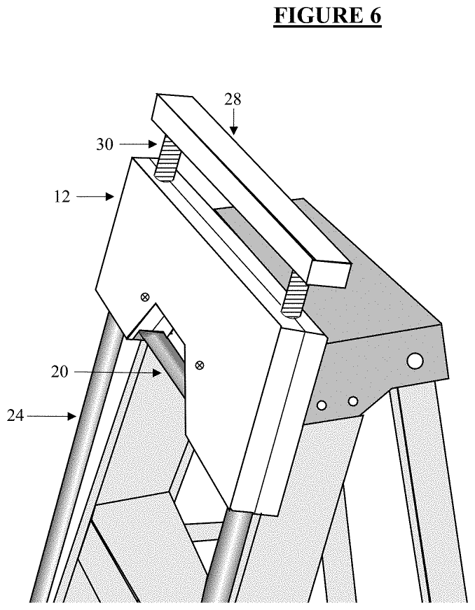

### DETAILED DESCRIPTION OF THE INVENTION

The housing component is comprised of two identical halves that, when sandwiched together, create an enclosure allowing for the attachment of the various mechanical components of the Ladder Lift device. It provides a support means for the stationary release frame guide (22) and a mounting means to an A frame ladder by way of thru-bolts or other appropriate mounting hardware. Its composition is of a material that is lightweight and made via an injection molding process or other machining processes.

The release cams (16), release handle frame (18), and release handle (20) assembly act against the spring-loaded clamps (26) of the Ladder Lift by sliding vertically within the housing to open the spring-loaded clamps (26) of the Ladder Lift. When released, the release handle (20) is returned to its upper stationary position by way of the spring action of the spring-loaded clamps (26).

on the outside of each vertical edge of the rectangular frame, and fitted around a release frame guide to facilitate sliding of the release to activate the ladder lift spring loaded clamps.

1. A housing and release handle assembly for housing and mounting the release mechanism of a ladder lift device comprising:
a. a separable housing having two halves identical in size, shape and internal structure to be sandwiched together with fasteners;
b. a sliding handle comprised of a rectangular frame with cams to engage a ladder lift mechanism;
c. a release frame guide to facilitate sliding of the release.

2. A multiple-piece enclosure for holding and allowing operation of the mechanical components of an extendable horizontal lifting device to be mounted to a ladder and comprising:
a. two identically structured halves with internal attachment points to hold in place the components of an extendable horizontal lifting device;
b. a handle frame-work that slides;
c. a stationary handle frame-work guide;
d. release cams to engage the lifting device releases.

3. An enclosure comprising:
a. equally sized enclosure halves with mounting locations to enclose the mechanics of a telescoping horizontal support device and permitting the mounting thereof to a ladder;
b. a sliding release handle with cams;
c. a centrally located stationary framework for guidance of a release handle;
d. openings through the enclosure's thickness to allow for the passage and securing of the lifting device slide tubes;
e. a window in the housing to facilitate access to the release handle.
